(19) United States
(12) Patent Application Publication
(10) Pub. No.: US 2009/0322177 A1
(43) Pub. Date: Dec. 31, 2009

(54) ELECTROMAGNETIC ACTUATOR

(76) Inventor: Guruge Elmo Laksham Perera, Hertfordshire (GB)

Correspondence Address: KOPPEL, PATRICK, HEYBL & DAWSON, 2815 Townsgate Road, SUITE 215, Westlake Village, CA, 91361-5827, US

(21) Appl. No.: 12/158,965

(22) PCT Filed: Dec. 21, 2006
(86) PCT No.: PCT/GB2006/004844

§ 371 Date: Nov. 24, 2008

(30) Foreign Application Priority Data
Dec. 21, 2005 (GB) 0526023.7

(51) Int. Cl. H02K 3/04

(52) U.S. Cl. 310/195

(57) ABSTRACT

An electromagnetic actuator for generating rotary motion, the actuator comprising an armature assembly and a stator assembly, the armature assembly having a plurality of magnets arranged in a ring shape, and a stator assembly comprising an electromagnet and at least on currently carrying conductor preferably arranged in a coiled configuration such that energisation of the coil causes the electromagnet to become active, and further comprising a shaft rotatable relative to the stator housing and with the armature assembly when the coil is energised.

The present invention relates to electromagnetic actuators and particularly relates to an electromagnetic actuator for generating rotary motion for direct application in situations where such motion is desirable.

Linear electromagnetic actuators are known and are typically based on powerful permanent magnets which can generate large forces. These types of actuators may be adopted for applications requiring rotational movement by using appropriate gearing or linkage mechanisms being connected to the output of the linear actuator.

The problem with such an arrangement is that the overall size of the arrangement will be large, and the operation thereof can be complicated. Moreover, the arrangement is likely to have restricted use in only certain applications.

Accordingly, the present invention proposes an electromagnetic actuator adapted to generate rotary motion for direct use in applications for which such motion is desirable.

From a first aspect the present invention provides n electromagnetic actuator comprising an armature assembly formed of a magnetic arrangement comprising a plurality of permanent magnets in a ring shaped configuration, and a stator assembly comprising an electromagnet and at least one current carrying conductor arranged with respect to the electromagnet such that energisation of the current carrying conductor causes the electromagnet to be in an active state, wherein the armature assembly is adapted to rotate with respect to the stator assembly, the actuator further comprising a shaft rotatably connected to the stator assembly but attached to the armature assembly such that energisation of the current carrying conductor causes rotation of the shaft.

In one embodiment, the armature assembly is arranged to rotate around the stator assembly. In another embodiment, the armature assembly is arranged to rotate within at least part of the stator assembly.

The actuator utilised in the present invention is capable of applying large torques and negotiate part or full rotation of an armature within a stator assembly.

In order that the present invention be more readily understood, embodiments thereof will be described with reference to the accompanying drawings in which:

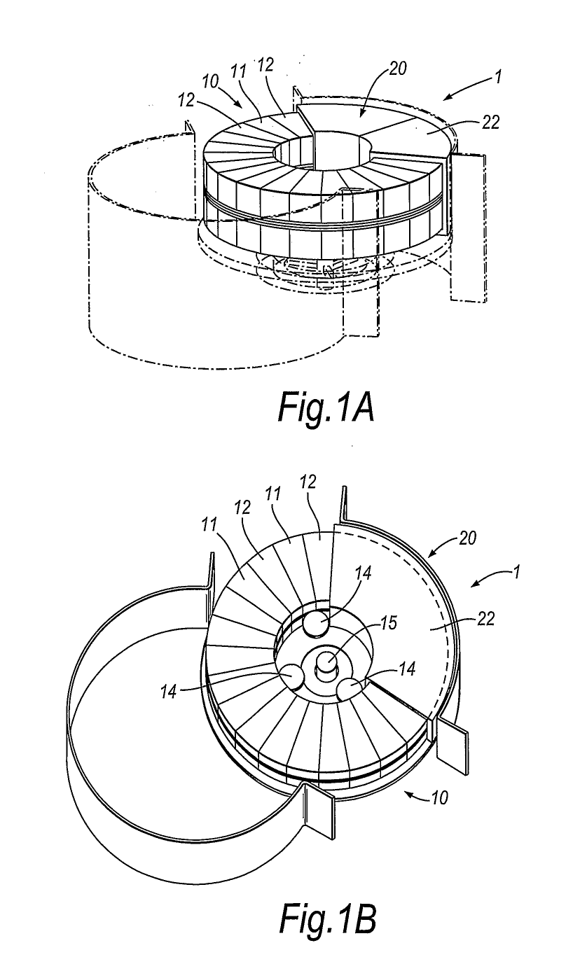

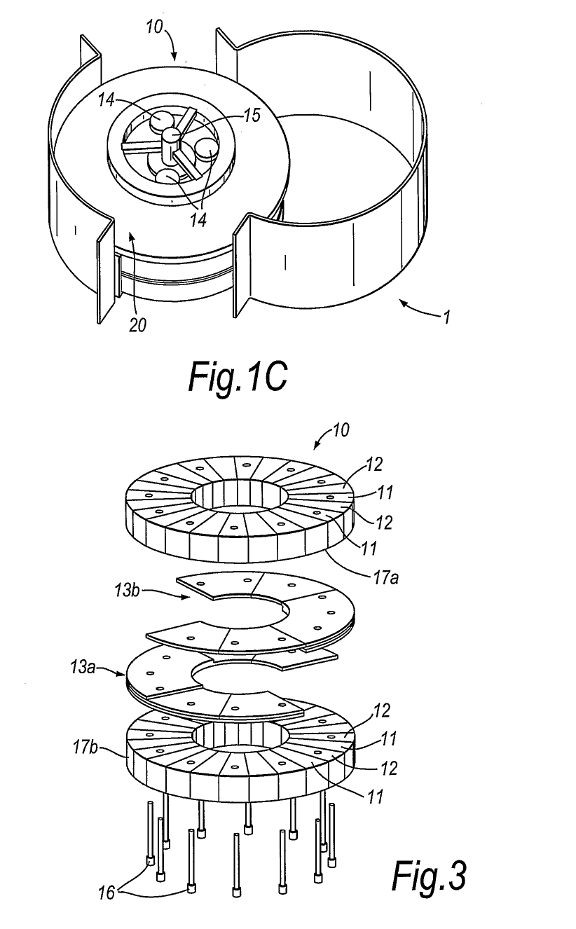

FIG. 1A shows a first perspective view of an actuator according to an embodiment of the present invention;

FIG. 1B shows a second perspective view of the actuator shown in FIG. 1A;

FIG. 1C shows a third perspective view of the actuator shown in FIG. 1A;

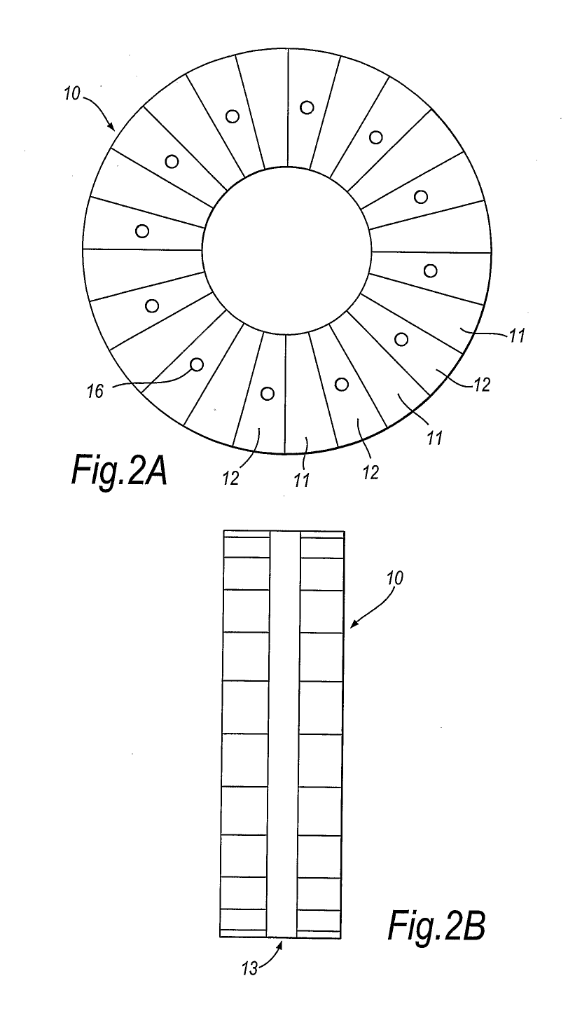

FIG. 2A shows a front schematic view of the armature of an actuator assembly utilised in the actuator of FIG. 1A;

FIG. 2B shows a side schematic view of the armature assembly of FIG. 2A;

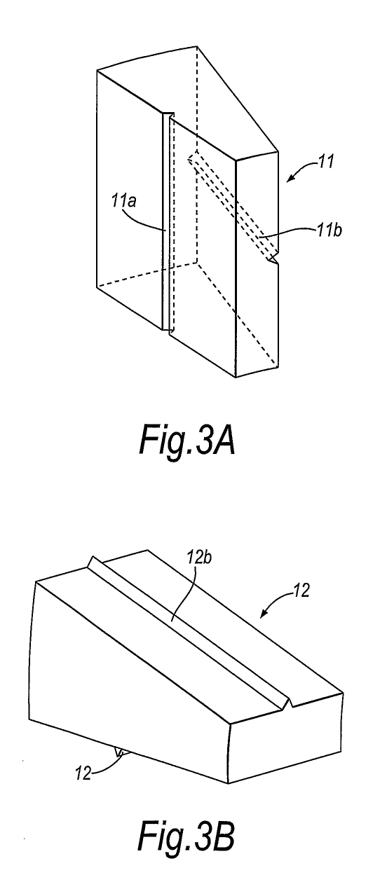

FIG. 3 shows an exploded perspective view of the armature assembly of FIG. 2A;

FIG. 3A shows a perspective view of a magnetic element of the armature assembly of FIG. 3;

FIG. 3B shows a perspective view of a pole piece of the armature assembly of FIG. 3;

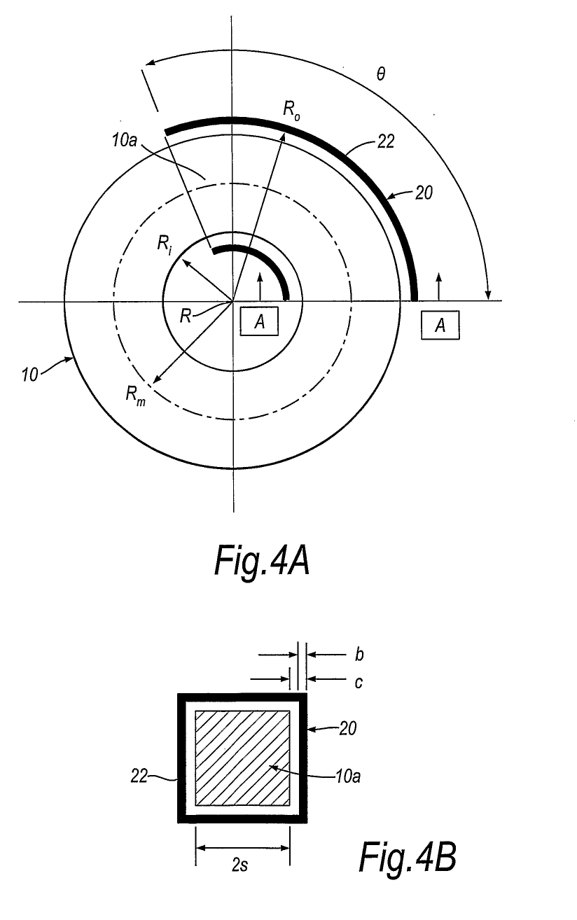

FIG. 4A shows a schematic geometrical view of the actuator of FIG. 1A;

FIG. 4B shows a cross-sectional view of the actuator in FIG. 4A taken along the line A-A;

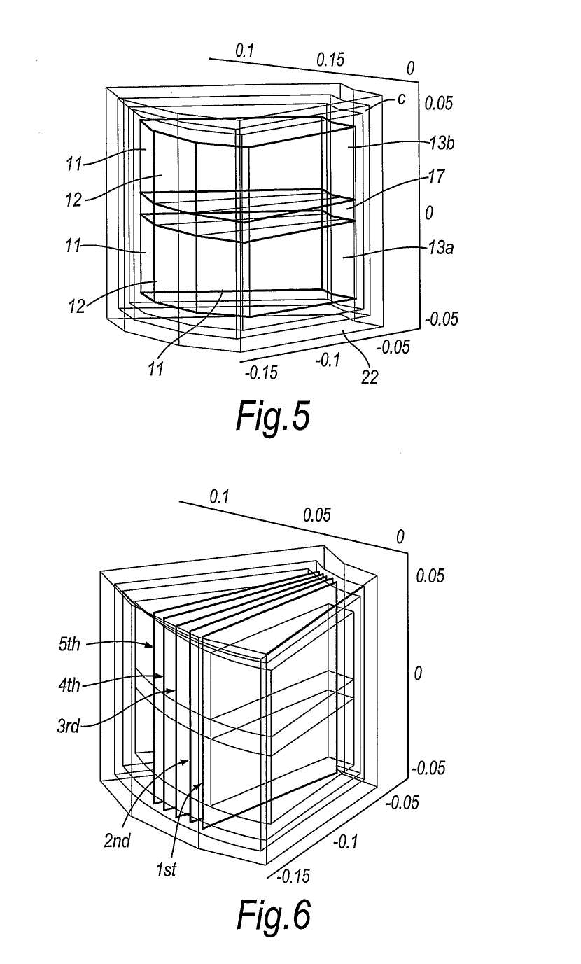

FIG. 5 shows a perspective transparent view of a portion of the actuator in FIG. 1A;

FIG. 6 shows a perspective transparent view of a portion of the actuator in FIG. 1A including first to fifth planes used for plotting the magnetic flux density patterns;

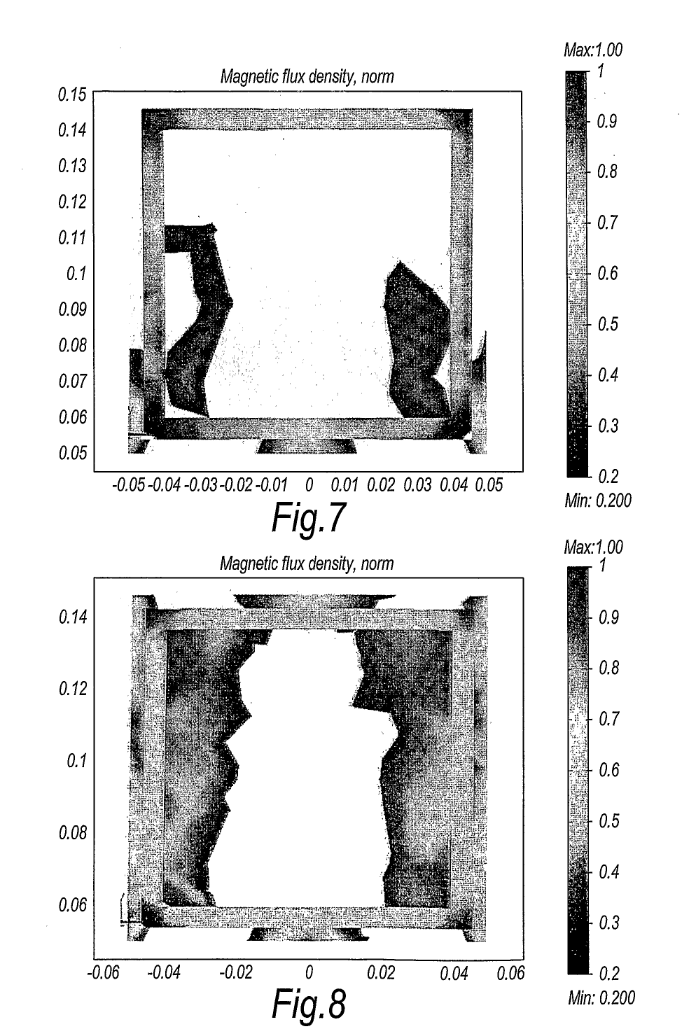

FIG. 7 shows a magnetic flux density pattern of the first plane shown in FIG. 6;

FIG. 8 shows a magnetic flux density pattern of the second plane shown in FIG. 6;

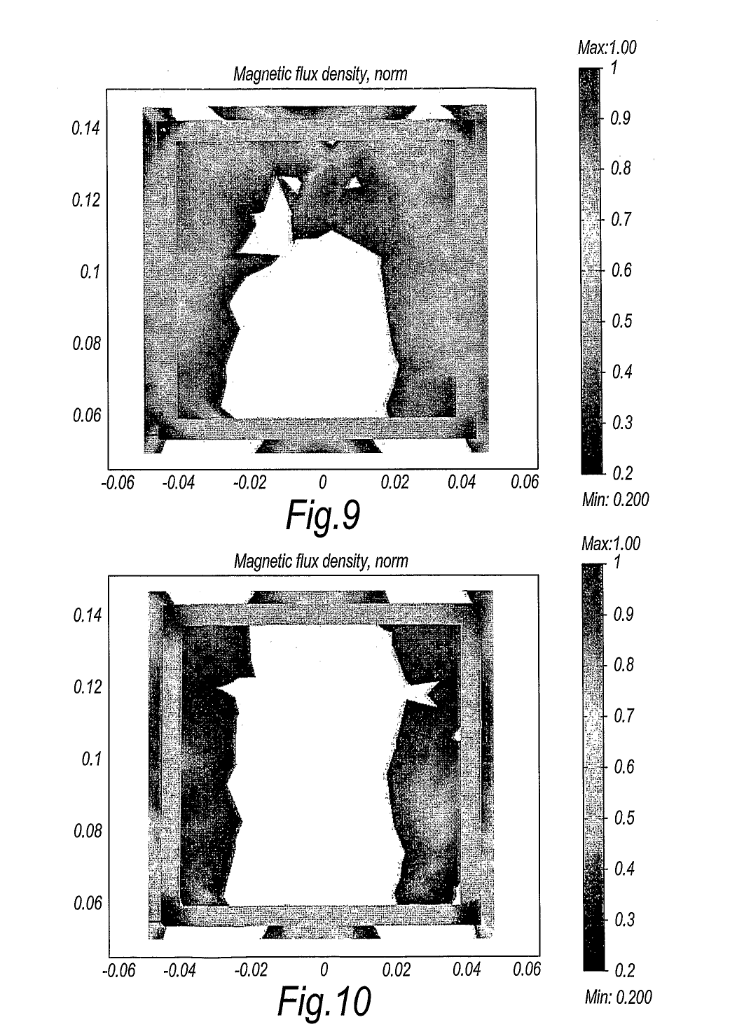

FIG. 9 shows a magnetic flux density pattern of the third plane shown in FIG. 6;

FIG. 10 shows a magnetic flux density pattern of the fourth plane shown in FIG. 6;

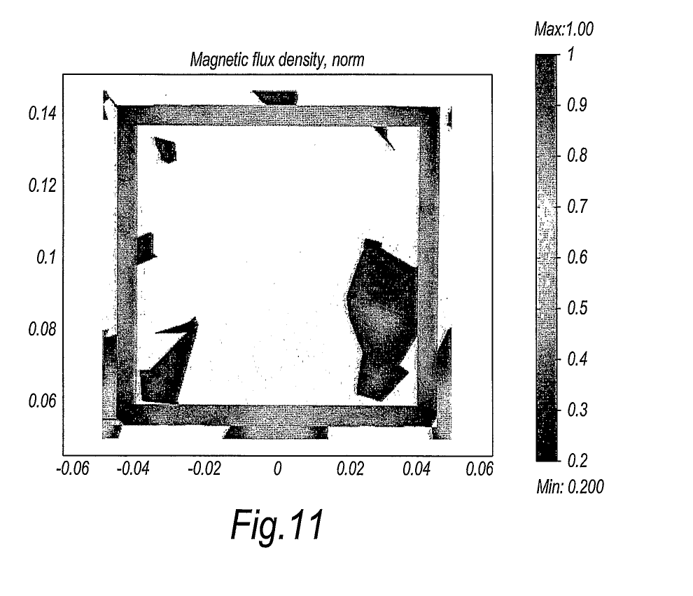

FIG. 11 shows a magnetic flux density pattern of the fifth plane shown in FIG. 6;

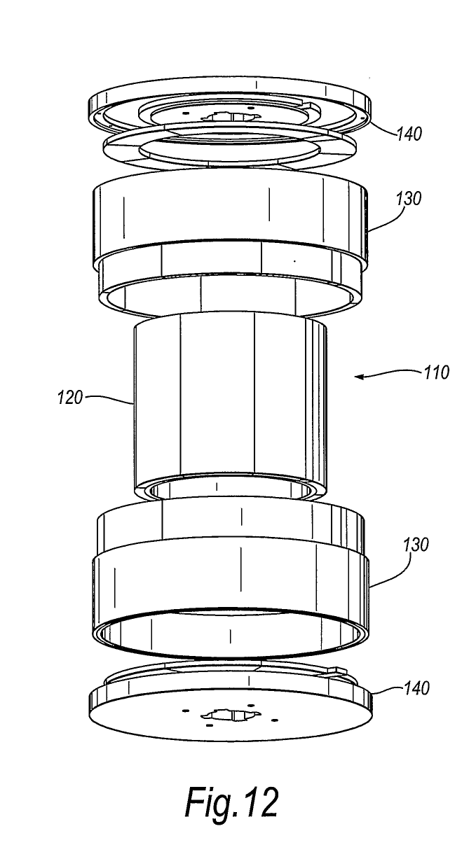

FIG. 12 shows an exploded perspective view of an armature assembly used in an alternative embodiment of the invention;

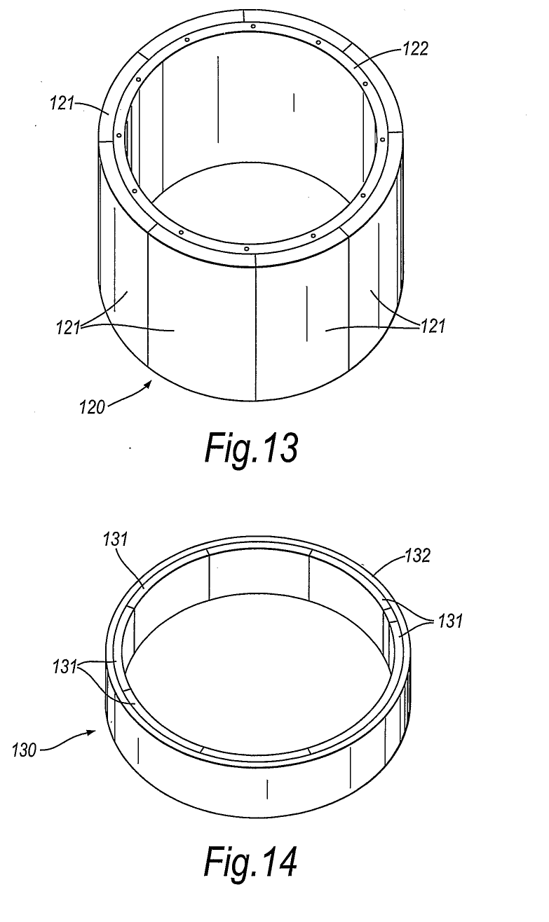

FIG. 13 shows an inner radial magnet arrangement used in the armature assembly of FIG. 12;

FIG. 14 shows an outer radial magnet arrangement used in the armature assembly of FIG. 12;

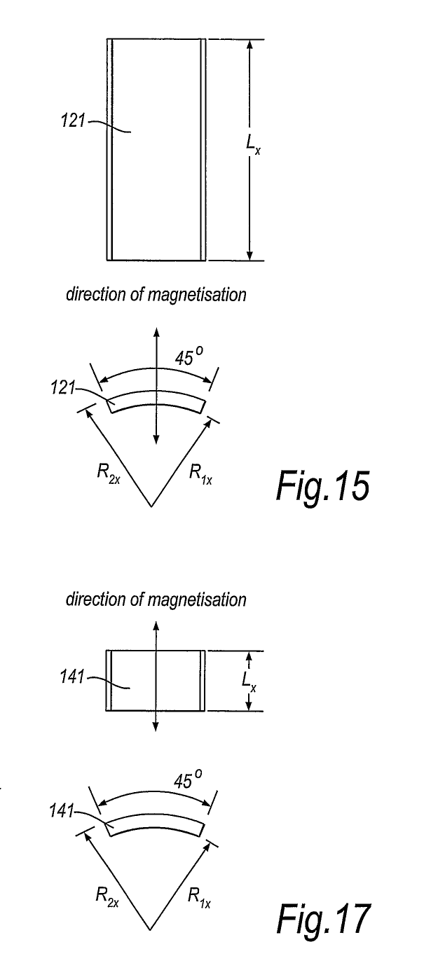

FIG. 15 shows a geometric view of one magnet used in the radial magnet arrangement of FIG. 13;

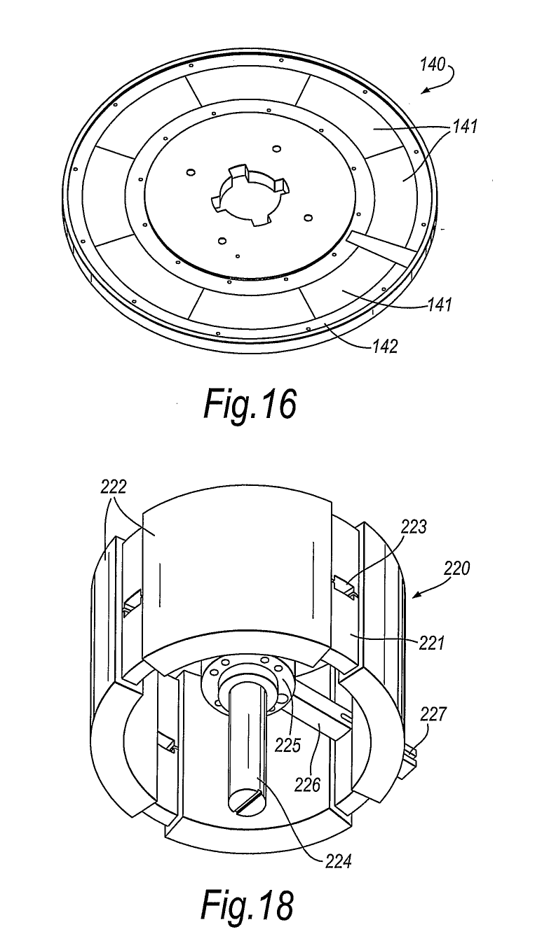

FIG. 16 shows an axial magnet arrangement used at each end of the armature assembly of FIG. 12;

FIG. 17 shows a geometric view of one magnet used in the axial magnet arrangement of FIG. 16;

FIG. 18 shows a perspective view of a stator assembly used with the armature assembly of FIG. 12 to form an actuator according to an alternative embodiment of the invention;

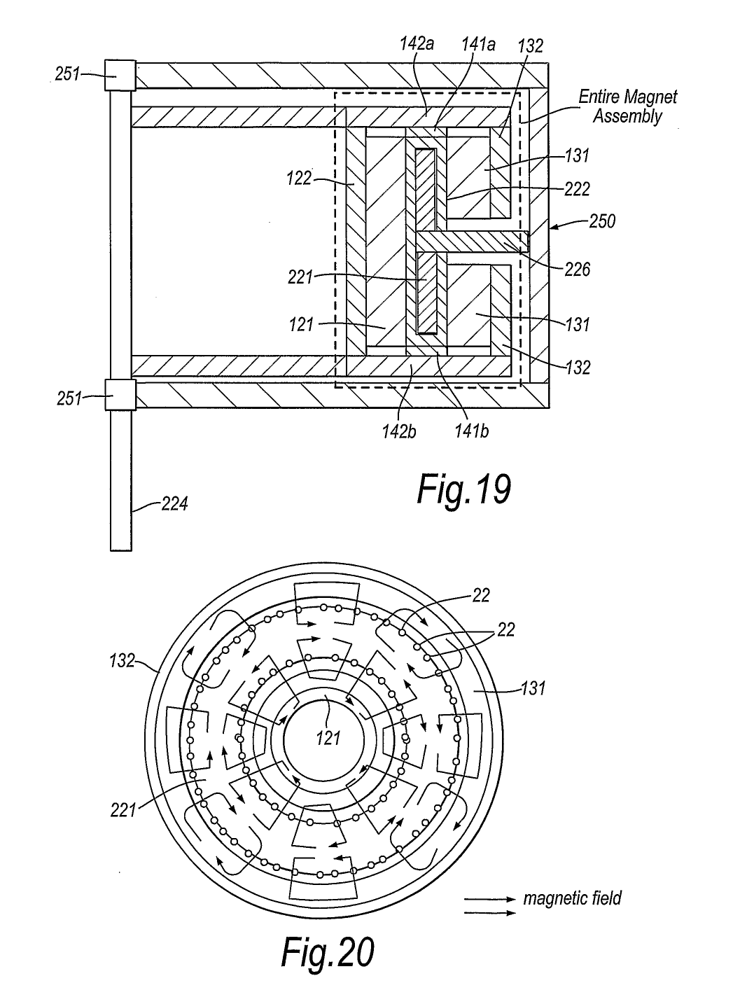

FIG. 19 shows a cross sectional view of one side of the actuator taken from the actuator shaft to one side of the outer housing of the actuator according to the alternative embodiment when in an assembled form;

FIG. 20 shows a magnetic field pattern in the actuator according to the alternative embodiment.

A preferred embodiment of the present invention will be described by referring to an actuator 1 which comprises two major components also present in a linear actuator: an armature assembly 10 and stator assembly 20. The actuator 1, however, differs to a typical linear electromagnetic actuator (not shown) by being formed of a ring shape with a rectangular or circular cross-section. This differs to a linear actuator where a rectilinear stator channel is provided for an armature assembly to move therethrough.

The basic assembly of the actuator 1 will be described with reference to FIGS. 1 to 4.

The armature assembly 10 is assembled using a plurality of permanent magnets 11 and a plurality of soft iron pole pieces 12 having a sector shape. The size and the number of these is determined by the optimisation of flux density generated and is discussed in more detail later. The magnets 11 used are magnetised in the peripheral direction of the armature assembly 10 and are sandwiched in between the soft iron pole pieces 12. The adjacent magnets 11 are oriented in opposite magnetisation directions, hence repel each other. The effect of this arrangement results in a high radial magnetic flux density emanating from the pole pieces 12, in alternate directions, i.e., radial inwards and outwards, for successive poles. This arrangement of placing magnets 11 and pole pieces 12 alternately is similar to the case of a typical linear actuator. Conversely to a linear actuator, however, the magnets 11 and poles 12 are assembled to form the ring shaped armature assembly 10 using a split armature base ring (SABR) 13 which facilitates the placement of stator coils which form part of the stator assembly 20, to surround the armature assembly 10. The SABR 13 is described later.

With particular reference to FIGS. 4A and 4B, a section 10a of the armature ring 10 having an arc angle of θ and width 2s is surrounded by the stator assembly 20 which comprises a soft iron case 22 of appropriate wall thickness b, leaving a space c to locate electrical winding forming the stator coils (not shown). The electrical winding will be firmly attached and supported by the iron case 22. The iron case 22 also serves to form the magnetic circuit (not shown) along with the armature assembly. The radial flux from the armature poles 12 is normal to the direction of current flowing in the stator coils (not shown). The interaction of the current with the magnetic flux generates a tangential force on the armature 10 generating a torque about the axis of rotation R. The method used will allow either part or full number of rotations, as required by the application. In particular, the amount of rotation can be controlled by controlling the current delivered to the coils.

The construction of armature assembly is shown in more detail in FIG. 3. The use of the SABR 13 is necessary to be able to place pre-fabricated stator coils (not shown). The SABR 13 is made in two pieces, 13a and 13b, formed of a suitable metal such a aluminium alloy or titanium and are positioned between the magnets 11 and pole pieces 12, which are themselves split in two half portions 17a and 17b. The pole pieces 12 (in 17a and 17b) and the SABR are provided with holes therethrough. These holes are aligned and receive elongate studs 16 to fix the pole pieces of one part 17a to the other part 17b, the SABR getting sandwiched in between.

The armature 10 is supported and centred by the use of three spur gears 14 and an internal spur gear on the inside face of the SABR 13. There are several roller/pins acting within a groove on the outer surface of the SABR 13.

The actuator 1 is designed so that two or more can be combined to give extra torque capacity. By placing an appropriate socket (not shown) on the top of central shaft 15, manual operation will be possible using a suitable wrench.

The details of the shape of magnets 11 and pole pieces 12 is shown in FIGS. 3A and 3B. The use of a v-grooves 11a, 11b locks the magnets 11 in position when the pole pieces 12 are fixed to the SABR 13 using the studs 16. The pole piece 12 comprises a corresponding ridge 12b to lock the pole piece 12 into place against a v-groove 11a of magnet 11 on one side of the pole piece 12. In addition, the pole piece 12 comprises a further corresponding ridge 12a to join the pole piece 12 with the v-groove 11b of another magnet 11 on the other side of the pole piece 12. Therefore the magnets 11 are sandwiched between pole pieces 12 without requiring any type of screw threading mechanism between the magnets 11 and pole pieces and moreover, avoids making holes in the magnets 11.

In this embodiment, the ridges 11a, 11b on respective opposing faces of the magnets 11 are aligned perpendicular to each other. It follows that this is also the case for the ridges 12a, 12b of the pole piece 12 in that they are arranged on opposing faces perpendicular to each other. This allows the force between the surrounding pole pieces of a particular magnet to be balanced.

It will be appreciated that other shapes and/or alignment of grooves 11a, 11b and corresponding ridges 12, 12b may be utilised to form the coupling between magnets 11 and pole pieces 12. For example, rectangular grooves and ridges (not shown) may be used.

FIGS. 4A and 4B shows the geometrical parameters of the actuator 1 required in theoretical model equations. From the geometry analysis of the arrangement in FIGS. 4A and 4B, the following is determined:

Rᵢ=Rₒ−2(s+b+c) (3.1)

Rₘ=Rₒ−(s+b+c) (3.2)

where
Rₒ=outer radius of actuator
Rₘ=mean radius of actuator
Rᵢ=inner radius of actuator

The volume of the stator coils that may be accommodated opposite the pole pieces is given by

$${V}_{e} = {F}_{mp} \cdot {P}_{f} [ \frac{θ}{360} 2 π {R}_{i} ] {A}_{f} \qquad ( 3.3 )$$

where
Fₘₚ=Fraction of angle occupied by pole pieces to the angle occupied by magnets in the ring armature
Fₚ=Packing factor for stator coils

A_{f}=cross-sectional area of coil space=4(s+c)²−s² (3.4)

From the electromagnetic theory

T=Torque generated=BₘJVₑRₘ (3.5)

where
Bₘ=mean magnetic radial flux density in coil space over pole pieces, Tesla
J=current density in coils, amp/m²

The ohmic heat dissipation in the stator coils is given by

$$Q = \frac{{( T / {R}_{m} )}^{2}}{σ {B}_{m}^{2} {V}_{e}} , W \qquad ( 3.6 )$$

where
σ=Electrical conductivity of coil material, 1/(ohm metre)

From eqns. (3.5) and (3.6)

$$\begin{matrix}T = {B}_{m} {R}_{m} \sqrt{σ {V}_{e} Q} & ( 3.7 ) \\ J = \sqrt{\frac{σ Q}{{V}_{e}}} & ( 3.8 )\end{matrix}$$

Eqns. (3.7) and (3.8) enable the calculation of T and J for given Q.

Using the above equations for the typical design where:—

### R=150 mm

s=40 mm
b=6 mm
c=7 mm
θ=110°
σ=5.77 e 07 1/(ohm m) (copper coil)
Bₘ=0.6 (using Neodymium, Boron, Cobalt, Iron magnets with Bᵣ=1.3 Te)
we get

T=6.34\sqrt{Q}

and

J=530.5e03\sqrt{Q}

As an example for Q=2000 W, we get for this typical design

T=283 Nm

J=23.73 E06 Amp/m²

As is apparent from Eqn. (3.7) torque, T, produced by the actuator 1 is proportional to the mean radial flux density above pole pieces 12. This in turn depends on Bᵣ, the remnant flux density, of permanent magnets 11 used and the geometry of the armature assembly 10.

FIG. 5 shows a transparent perspective view of a section of the actuator 1 consisting of two magnets 11 and one pole piece 12. This section is part of the armature assembly 10 located within the stator assembly 20. FIG. 6 shows the locations of flux pattern locations which are determined in planes numbered 1st to 5th. Further analysis of the typical design discussed above can be carried out and particularly the flux density patterns of the certain planes numbered 1st to 5th in FIG. 6 along the circumference of the typical design are determined as shown in FIGS. 7 to 11.

FIGS. 7 to 11 are flux density patterns of the various planes shown in FIG. 6 and it is apparent from FIG. 9 that the third plane which represents the middle of the pole piece 12 shown in FIG. 5, exhibits the most dense magnetic flux density pattern.

The coils (not shown) of the stator 20 are excited using the power supply system already published by the present applicant and used for the linear actuator. Alternatively, traditional 3-phase controllers may be used. Computer control of the power supply provides flexible operation of the actuator.

An alternative embodiment where a gear drive is avoided and the use of the pole pieces is not required will now be described referring to FIGS. 12 to 20.

In this embodiment, an armature assembly 110 is formed of an inner magnet arrangement 120, two outer magnet arrangements 130, and two axial magnet arrangements 140. The radius of the inner magnet arrangement 120 is smaller than that of the two outer magnet arrangements 130 such that in an assembled position, the inner magnet arrangement 120 is arranged coaxially within the outer magnet arrangements 130. When assembled, the circumferential edge of the two outer magnet arrangements 130 do not meet but a gap exists. Each axial magnet arrangement 140 is positioned at an end of the actuator to form a magnetic path between the inner magnet arrangement 120 and the outer magnet arrangements 130 when the actuator is assembled.

As shown in FIG. 13, the inner magnet arrangement 120 comprises a plurality of magnets 121 arranged adjacent each other to form a ring shaped member. The magnets 121 are mounted on a circular soft iron support member 122 such that the magnets 121 cover the outer surface of the soft iron core member 122. The shape of each magnet is shown in FIG. 15 where it tales a rectangular shape which is curved to match the contour of the soft iron core member 122. The purpose of this arrangement is to provide magnetisation in a radial direction.

FIG. 14 shows one of the outer magnet arrangements 130 in more detail. The other arrangement 130 is identical. A plurality of magnets 131 are arranged adjacent each other and mounted onto the inner surface of a soft iron support member 132. In a similar manner to the inner magnet arrangement 120, the magnets 131 cover the inner surface of the soft iron support member 132. This magnetic arrangement has a similar purpose to the inner magnet arrangement 120 and provides magnetisation in a radial direction.

FIG. 16 shows the end part of the armature assembly which is used to provide a physical connection between the different magnet arrangements 120,130 and a magnetic path between the different sets of magnets in each arrangement 120,130. The axial magnet arrangement 140 comprises a plurality of magnets 141 arranged differently to the magnets in the inner and outer magnet arrangements 120,130 in order to provide an axial magnetic field. In this embodiment this is achieved by arranging flat plat magnets adjacent each other such that their ends are coupled which forms a flat plated ring. The magnets 141 are mounted on a supporting plate 142 which in an assembled position is in turn connected to the soft iron support members 121,131 of each magnet arrangement 120,130. This connection can be achieved in any manner and preferably by way of holes being provided on the respective plates to receive a screw or the like and connect the plate to the members 121,131. It will be appreciated that the other axial magnet arrangement 140 will be used in a similar manner at the other end of the actuator.

The shape of each magnet 141 in the axial magnet arrangement 140 is shown in more detail in FIG. 17. As shown, the direction of magnetisation is axial compared to radial in FIG. 15. This advantageously completes the magnetic path.

A stator assembly 220 is shown in FIG. 18 and this is formed from a soft iron tubular core 221 which has a radius such that it can fit between the inner and outer magnet arrangement 120,130 when the actuator is assembled. The will have the shape of a circular ring preferably with a rectangular cross-section. A set of coils 22 are wound over and around the wall of the soft iron ring 221. Grooves 223 are provided on the iron ring 221 at spaced intervals to pass leads of the coils 22 and provide a more compact arrangement. A shaft 224 passes through a central axis of the iron ring 221 and is connected to the iron ring 221 via a central support bearing 225 and a spoke 226 which passes through a hole in the iron ring 221 and extends radially from the shaft 224. As shown more clearly in FIG. 19, the spoke 226 is fixed to outer housing 250 and passes through the gap between the two circumferential edges in the outer magnet arrangements 130 of the armature assembly 110. The outer housing 250 houses the entire armature assembly 110 and stator assembly 220. A groove 227 on the spoke 226 enables the coil leads 22 to be passed to the outer housing 250 and thus provide external control. Although not shown in the diagram, the core 221 is supported by four spokes 226 and these spokes are in turn supported by the outer housing 250. The main advantage of this design is that the coils wound on the iron core have a good mechanical support.

The coils 222 are sub-divided into a number of individual coils. Current flow through these coils 222 is controlled by an electronically controlled power supply system (not shown) in conjunction with a rotary encoder (not shown). The encoder signal is used to decide the correct voltage direction and magnitude.

FIG. 19 shows cross section of the actuator from one side in assembled form, and the entire magnet assembly is shown as a dashed line. The shaft 224 is rotatably mounted on the housing 250 via bearings 251. Accordingly the shaft 224 is capable of rotating about the bearings 251. The stator assembly 220 is fixed to the housing 250 and thus does not move. The magnetic armature assembly 110 is connected to the shaft 224 such that rotation of the armature will cause rotation of the shaft 224.

The magnetic path in the actuator is achieved by four main set of magnets. These magnets are the outer radial magnets 131, the inner radial magnets 121, the upper axial magnets 141a, and the lower axial magnets 141b. The magnets are either magnetised in radial or axial directions as explained above. The dimensions of these magnets shown as LₓR₁ₓ, and R₂ₓ in FIGS. 15 and 17 are appropriately chosen so that they surround the electrical current carrying coils 222. The four sets of magnets required are as specified below:

1. 16 radial magnetised outer magnets, FIG. 15
axial length of Lₓ=2L₁+Sₚₒₖₑ, R₁ₓ=Rᵢₙ₂, R₂ₓ=Rₒᵤₜ₂
   2. 8 radial magnetised inner magnets, FIG. 15
axial length of Lₓ=L₁, R₁ₓ=Rᵢₙ₁, R₂ₓ=Rₒᵤₜ₁
   3. 8 axially magnetised top magnets, FIG. 17, axial length of Lₓ=L₃
axial length of Lₓ=L₃, R₁ₓ=Rₒᵤₜ₁, R₂ₓ=Rᵢₙ₂
   4. 8 axially magnetised bottom magnets, FIG. 17, axial length of Lₓ=L₃
axial length of Lₓ=L₃, R₁ₓ=Rₒᵤₜ₁, R₂ₓ=Rᵢₙ₂

The pattern of magnetic field produced in a cross-section due to inner and outer radial magnets 121,131 is shown in FIG. 20. Common reference numerals indicate the same features of other figures. The normal field produced on the coils has alternating radial out and in directions. The effect of this is to produce a one-directional torque on the shaft 224 when coils 222 carry a current. A similar one-directional torque is produced by the magnetic field due to top and bottom axial magnets 141a,141b. The field pattern produced is similar to that shown in FIG. 20, except it will be in a radial plane passing through the axis of the actuator's shaft 224.

As mentioned above the four sets of magnets are mounted on corresponding soft iron supports and these soft irons complete the magnetic circuit as shown in FIG. 20. Computer simulation of the magnetic circuit on any suitable application such as COMSOL showed the efficacy of this method, and the strength of fields over the coils is about 0.7 Te using Neodium-iron_boron magnets. This is similar to the design of a linear actuator, for which the current applicant has filed patent applications.

The sets of magnets form an integral assembly and will rotate along with the shaft 224 of the actuator. Sufficient clearance between the coil outer surface and the inner magnet surfaces will be provided for frictionless motion. The main bearings 251 on the actuator shaft will ensure proper alignment.

Accordingly, it is apparent that the present invention provides the following features and advantages:

i) The actuator is capable of applying large torques and negotiate part or several full rotations. The use of coils surrounding the entire armature periphery gives an optimum force generation.
ii) The ability for full rotational motion and rotation by a number of revolutions usually gives a high static stiffness.
iii) A modular design is developed where additional torque capacity may be achieved by using two units in tandem. This is cost effective for general purpose applications. Individual units may also be designed for specific applications.
iv) The design of the stator and armature allows the stator coils to surround the armature, making a maximum of coil length generate electromagnetic force for given current flowing. This will result in a very efficient actuator.
v) Provision of manual override for the actuator may be easily organised.
vi) The flexible computer control of the actuator is feasible.
vii) The flexibility of operating the actuator through power supply to stator winding which is sub-divided into a number of individual coils. This offers the possibility for computer controlled smart operations.

The alternative embodiment which is a gearless design has the following additional advantages;—

i) Absence use of gears in achieving large torques at low rotational controllable speeds;
ii) An innovative lay out of permanent magnets to achieve orthogonal flux over coils for a linear actuator;
iii) Absence of pole pieces provides greater space for coils and simplifies the current switching and control;
iv) The lay out of magnets avoids repulsion forces between them, making the assembly of armature easier and also reducing the risk of explosive disintegration of the armature.

1. An electromagnetic actuator comprising an armature assembly formed of a magnetic arrangement comprising a plurality of permanent magnets in a ring shaped configuration, and a stator assembly comprising an electromagnet and at least one current carrying conductor arranged with respect to the electromagnet such that energisation of the current carrying conductor causes the electromagnet to be in an active state, wherein the armature assembly is adapted to rotate with respect to the stator assembly, the actuator further comprising a shaft rotatably connected to the stator assembly but attached to the armature assembly such that energisation of the current carrying conductor causes rotation of the shaft, wherein the armature assembly is arranged to rotate around the stator assembly.

2. The actuator of claim 1 wherein the magnetic arrangement of the armature assembly comprises a first magnet assembly, second magnet assembly and a third magnet assembly, the first magnet assembly arranged coaxially within the second magnet assembly, and the third magnet assembly arranged between the first and second magnet assembly, such that the first and second magnet assembly provides radial magnetisation and the third magnet assembly provides axial magnetisation.

3. The actuator of claim 2 wherein the electromagnet is in the form of a tubular member and the current carrying conductor is wrapped around part of the wall of the tubular member.

4. The actuator of claim 3 comprising a plurality of current carrying conductors, each conductor wrapped around different sections of the wall of the tubular member.

5. The actuator of claim 4 wherein the stator assembly further comprises at least one spoke passing through a groove in the tubular member, the spoke fixed to an outer casing of the actuator which is connected to the shaft in order to coaxially mount the stator assembly on the shaft.

6. An electromagnetic actuator comprising an armature assembly formed of a magnetic arrangement comprising a plurality of permanent magnets in a ring shaped configuration, and a stator assembly comprising an electromagnet and at least one current carrying conductor arranged with respect to the electromagnet such that energisation of the current carrying conductor causes the electromagnet to be in an active state, wherein the armature assembly is adapted to rotate with respect to the stator assembly, the actuator further comprising a shaft rotatably connected to the stator assembly but attached to the armature assembly such that energisation of the current carrying conductor causes rotation of the shaft, wherein the armature assembly is arranged to rotate within at least part of the stator assembly.

7. The actuator of claim 6 wherein the magnetic arrangement further comprises a plurality of pole pieces arranged between the permanent magnets.

8. The actuator of claim 7 wherein the magnets and pole pieces are connected to ring shaped plate.

9. The actuator of claim 8 further comprising another ring shaped plate and a further set of magnets and pole pieces connected to the other plate.

10. The actuator of claim 9 wherein the two plates, magnets and pole pieces are provided with corresponding holes so as to enable alignment of the plates, magnets and pole pieces and connection thereof.

11. The actuator of claim 10 wherein the each magnet comprises at least one projection and groove, and each pole piece comprises at least one corresponding groove and projection to enable locking of adjacent magnets and pole pieces.

12. The actuator of claim 11 wherein the electromagnet is in the form of a hollow casing formed of soft iron.

13. The actuator of claim 12 wherein the current carrying conductor is arranged in a coiled configuration on an inner surface of the casing.

14. The actuator of claim 3 wherein the stator assembly further comprises at least one spoke passing through a groove in the tubular member, the spoke fixed to an outer casing of the actuator which is connected to the shaft in order to coaxially mount the stator assembly on the shaft.

15. The actuator of claim 1 wherein the electromagnet is in the form of a tubular member and the current carrying conductor is wrapped around part of the wall of the tubular member.

16. The actuator of claim 10 wherein the each magnet comprises at least one projection and groove, and each pole piece comprises at least one corresponding groove and projection to enable locking of adjacent magnets and pole pieces.

17. The actuator of claim 1 wherein the electromagnet is in the form of a hollow casing formed of soft iron.
